(19) United States
(12) Patent Application Publication
(10) Pub. No.: US 2017/0023143 A1
(43) Pub. Date: Jan. 26, 2017

(54) TRANSMISSION ELEMENT DEVICE FOR TWO-WAY TIMING

(71) Applicant: BERY INTELLECTUAL PROPERTIES Szellemi Tulajdonjogokat Hasznositó és Kezelõ Korlátolt Fel, Budapest (HU)

(72) Inventor: Jósef BEREZNAI, Budapest (HU)

(73) Assignee: BERY INTELLECTUAL PROPERTIES Szellemi Tulajdonjogokat Hasznositó és Kezelõ Korlátolt Fel, Budapest (HU)

(21) Appl. No.: 15/113,473

(22) PCT Filed: Jan. 22, 2015
(86) PCT No.: PCT/HU2015/000004

§ 371 Date: Jul. 22, 2016

(30) Foreign Application Priority Data
Jan. 24, 2014 (HU) P1400030

(51) Int. Cl. F16K 21/10; F16K 31/122; F16K 21/12

(52) U.S. Cl. CPC F16K 21/10; F16K 21/12; F16K 31/1221; F16K 31/1225

(57) ABSTRACT

Transmission element device for two-way timing connected mechanically to the surface to be activated (15) of a timed apparatus operated by a controller (37), the surface to be activated (15) is linearly movable against counter-force. The transmission element (1) has a transmission element brake cylinder (7) filled with operating medium. The inner space of the transmission element brake cylinder (7) is divided into a first chamber (19) and a second chamber (21) by a linearly moving transmission element piston (9) having a sealing element (23). The transmission element piston (9) is provided with openings (25, 27) for ensuring the flow of the operating medium between the two chambers (19, 21) in an extent determined separately for each direction. The exit portion (5) of the transmission element (1) is in push contact with the surface to be activated (15), while the transmission element piston (9) is fastened to the controller (37).

The invention relates to a transmission element device for two-way timing connected mechanically to the surface to be activated of a timed apparatus operated by a controller, the surface to be activated is linearly movable against counter-force.

There are number of inventions dealing with timing and safe closing of valves but the reason that gave the idea of the present invention is that timing (especially for valves) is usually unidirectional, that is, regarding the direction of the movement mainly the timing of closing is important. This naturally also restricts the time of opening but only if the operating element (e.g. a press-button) intervenes systematically (in particular impulse-like), that is, from the time when the operating element moves back to zero setting. For example in patent application U.S. Pat. No. 7,175,154—assigned to the applicant of the present invention—FIGS. 7A and 7B show a timed feeder valve. Here a direct connection exists between valve stem 4′—in this example also presenting an operating element and valve 1. The disadvantage of this solution is that if the operating element gets stuck then valve 1 is not able to close, e.g. the tap remains open resulting in a significant waste of water (medium). The connection between the operating element and the valve should be made indirect e.g. by installing a suitable mechanical timing element. This structure should be able to open the valve while long-lasting opening of it is prevented.

The timing of the apparatus—or one of its element—substantially depends on the position of the operating element or on the operator of it and may cause unreliable operation or may result in inaccurate functionality. That is, any faults in functioning of the operating element e.g. caused by getting stuck, keeping pressed, wedging out would result in false timing preventing the valve from closing automatically as required. In this case the apparatus does not close down which is not merely a technical problem but it implies significant waste and causes environmental damage too. To sum it up this means that by means of the present invention i.e. installing a transmission element the apparatus will close down even if the operating element e.g. press-button remains pressed in, since transmission of power takes place indirectly due to the resistance of medium (drag).

Unreliable, vague closing may not only be caused by the malfunction of the operating element but also by the contamination which may clog the control-opening. The present invention can overcome this problem since by installing the transmission element fixedly, reversely it is also adapted for timing and it has the advantage that the device may be separated from the controlled space of the medium which may be contaminated, dangerous, cold or hot. It means that the control medium of the transmission element may remain sterile. In this manner reliable operation is guaranteed.

To solve these two problems the present invention proposes a transmission element for two-way timing by means of which the point of closing can be timed and also the duration of opening can be restricted. The device is applicable to eliminate both problems.

To achieve the aim of the present invention according to the above problem a transmission element mentioned in the introductory part is provided. The transmission element has a transmission element brake cylinder filled with liquid form or gaseous operating medium. The inner space of the transmission element brake cylinder is divided into a first chamber and a second chamber by means of a linearly moving transmission element piston provided with a sealing element. Further, the transmission element piston is provided with openings for ensuring the flow of the operating medium between the first chamber and the second chamber in an extent determined separately for the two directions. Between the exit portion of the transmission element and the surface to be activated there is a push contact while the transmission element piston is structurally fastened to the controller.

In another embodiment the transmission element is placed reversely, that is, the exit portion itself represents the controller while the activating shaft of the transmission element piston contacts to the surface to be activated through push contact.

The device can be used not only with valves but in other switching systems like electric press-buttons, e.g. for alarms or in cases where a wedged-in press-button or other mechanical structure causes unwanted operation.

The preferred embodiments of the invention will be described with reference to the attached drawings in which:

FIG. 1 is the sectional view of a first embodiment of the invention in its zero setting;

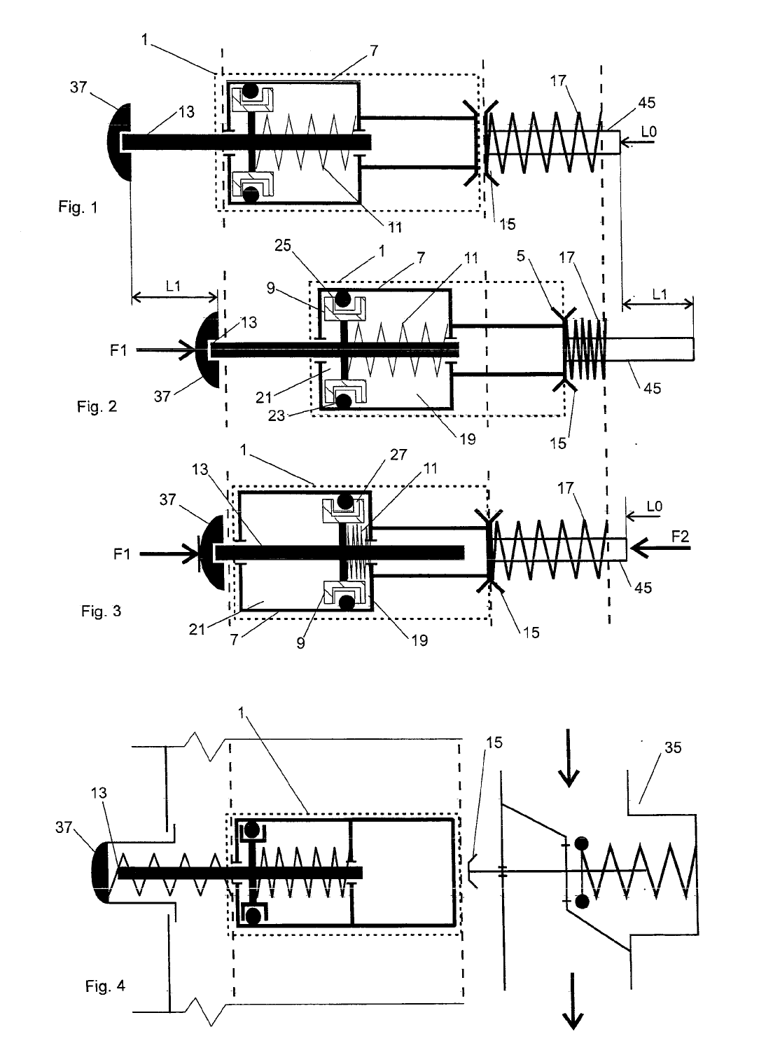

FIG. 2 shows the embodiment of FIG. 1 in an activated position;

FIG. 3 shows the embodiment of FIG. 2 in a position when timing is over;

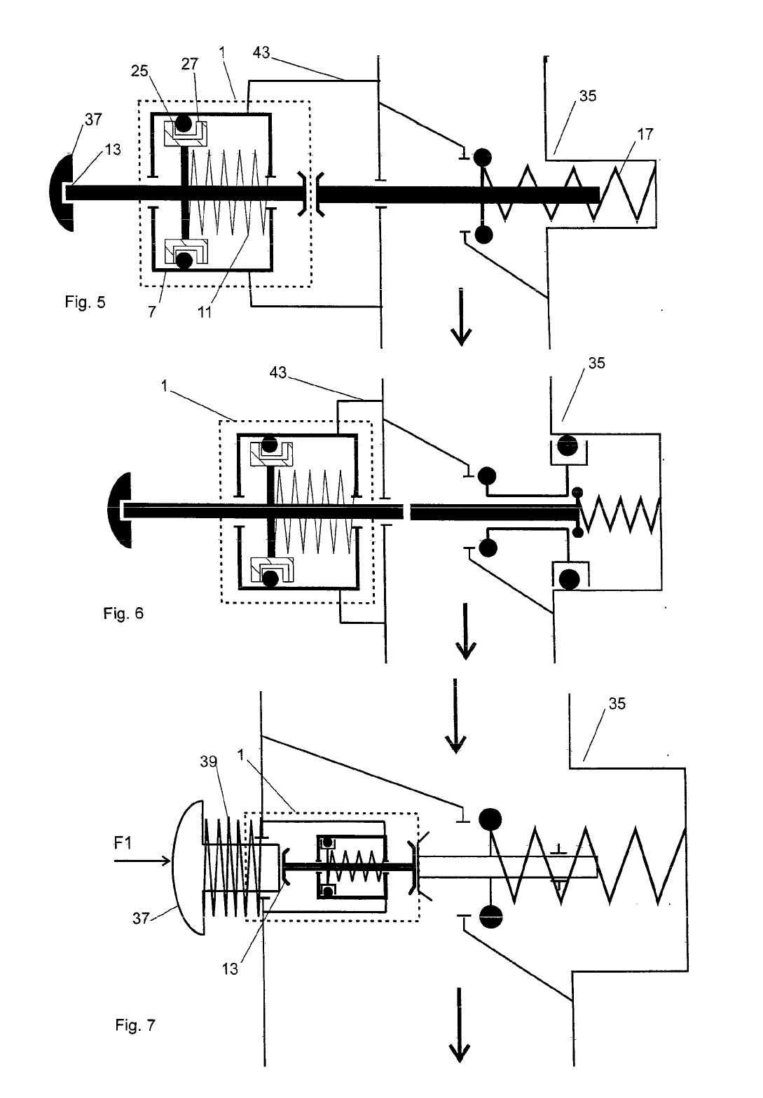

FIG. 4 is the sectional view of another embodiment applicable to control a valve;

FIG. 5 is the sectional view of a further embodiment attached to a valve by means of an external fixing element;

FIG. 6 is the sectional view of a further embodiment in which the position of the activating surface is different from the position shown in the previous embodiment;

FIG. 7 is the sectional view of a further embodiment in which the transmission element according to the invention is built in the inner portion of a valve;

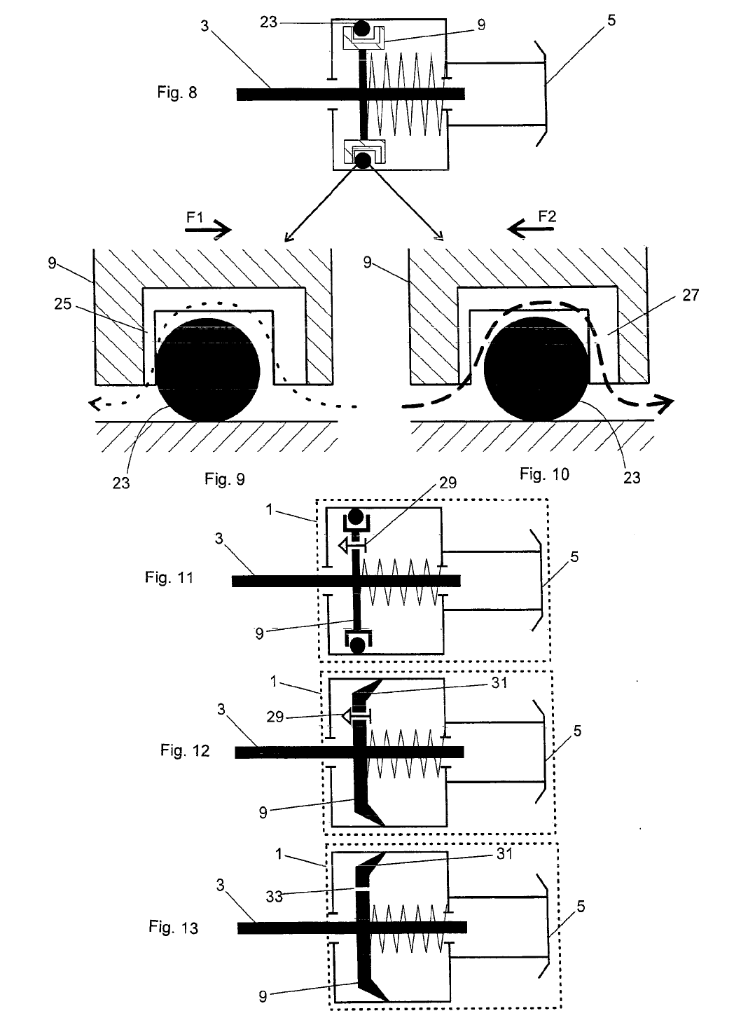

FIG. 8 is the sectional view of the transmission element piston combined with an O-ring;

FIG. 9 is a sectional view showing a first position of the O-ring of FIG. 8 and the formation of the associated opening for flow-through;

FIG. 10 is a sectional view showing a second position of the O-ring of FIG. 8 and the formation of the associated opening for flow-through;

FIG. 11 is the sectional view of an embodiment in which a micro-valve is built in the transmission element piston;

FIG. 12 is the sectional view of an embodiment in which a micro-valve is built in the transmission element piston and is provided with an edge sealing;

FIG. 13 is the sectional view of an embodiment in which a control-opening is built in the transmission element piston and is provided with an edge sealing;

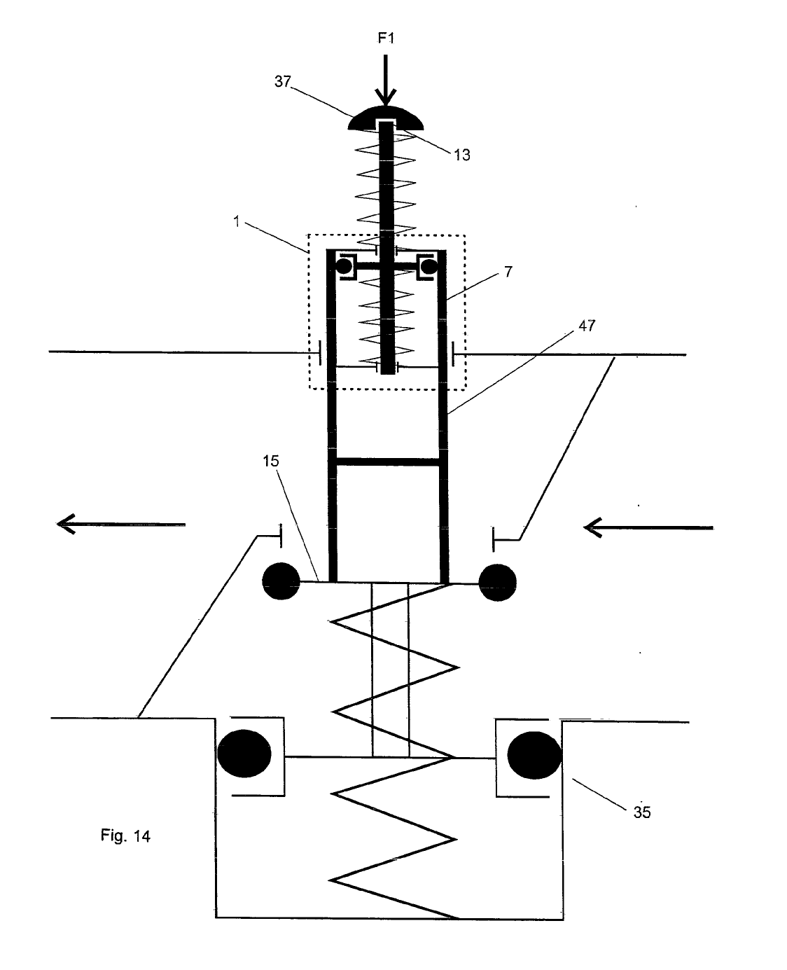

FIG. 14 shows a further embodiment in which the transmission element is connected to the surface to be activated by means of a rod assembly;

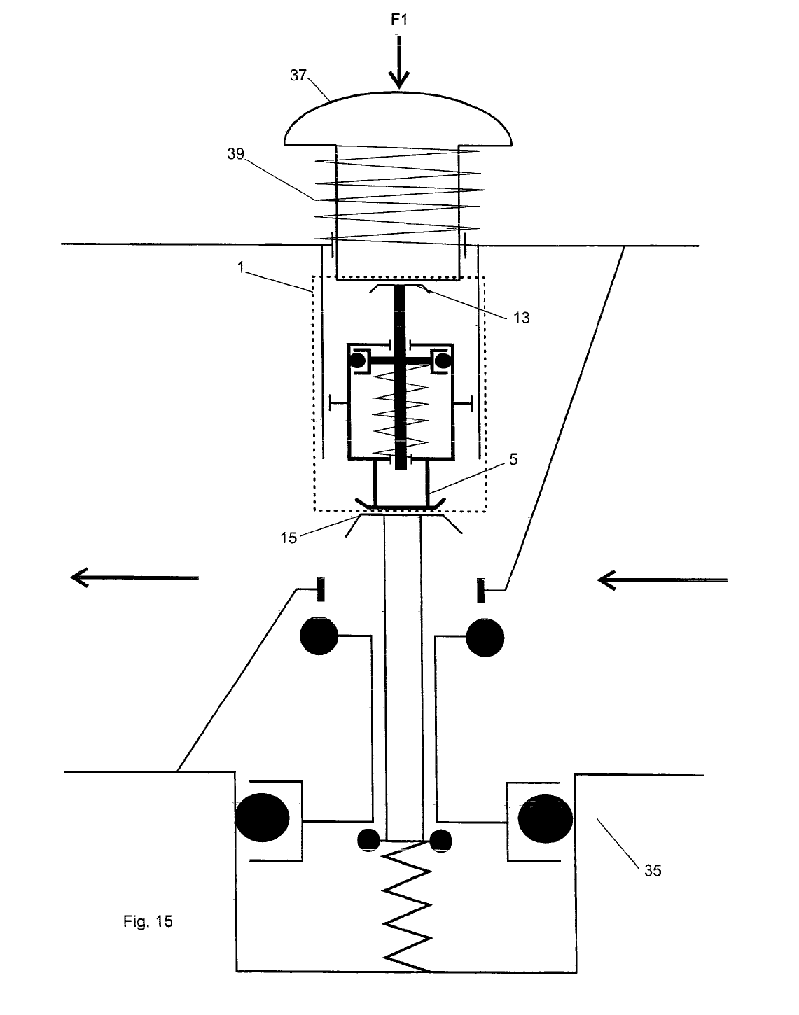

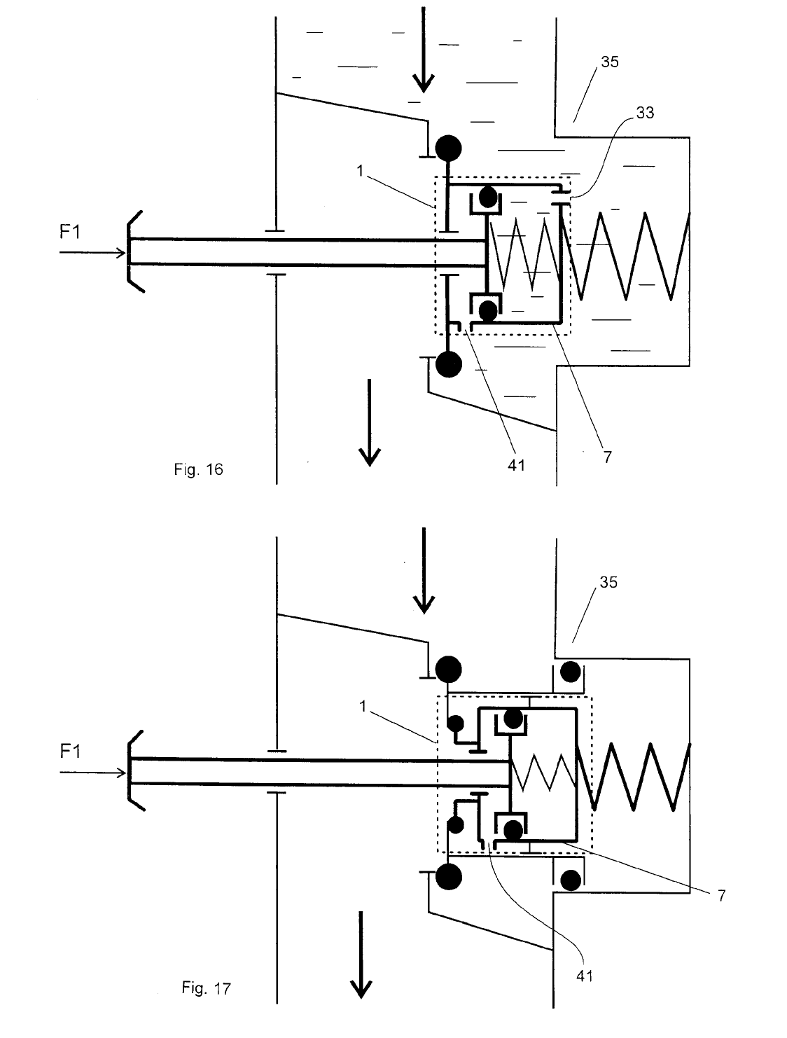

FIG. 15 shows a further embodiment in which the transmission element is built in the exiting side of a valve;

FIG. 16 shows a further embodiment in which the transmission element is provided with an equalizing bore-hole and built in the entering side of a valve;

FIG. 17 shows a further embodiment in which a dimensioned control-opening is formed; and

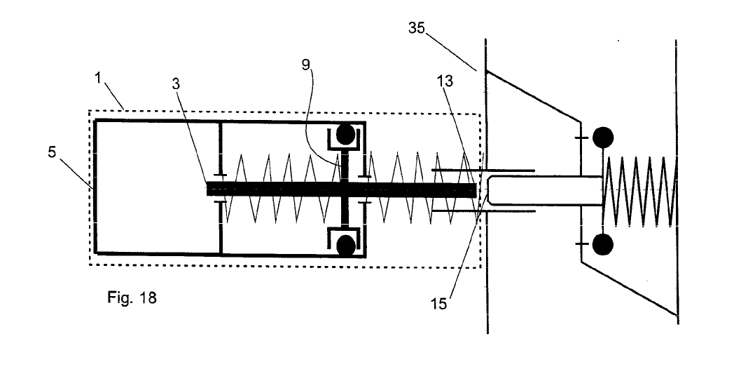

FIG. 18 shows a further embodiment in which the transmission element is built in reversely as compared to the previous embodiments.

FIG. 1 shows the transmission element according to the present invention in the state of rest determined by springs 11 and 17 when force is not applied on controller (e.g. press-button) 37. An activating shaft 13 and a transmission element brake cylinder 7 can be seen in FIG. 1. The portion to be activated 45 connected to the surface to be activated 15 may be e.g. a valve control rod which in the present example is in the state of rest, i.e. in a position L0 considering its possible range of longitudinal displacement.

In FIG. 2 the same arrangement can be seen but here the transmission element 1 is displaced due to force F1 applied on controller 37. The inner space of the transmission element brake cylinder 7 is filled with liquiform or gaseous operating medium and is divided into a first chamber 19 and a second chamber 21 by transmission element piston 9 provided with a sealing element 23. Due to the displacement spring 17 is pressed and correspondingly the portion to be activated 45 connected to the surface to be activated 15 is displaced by a length L1. Activating shaft 13 is fixed to transmission element piston 9 consequently force F1 acting on controller 37 also acts on transmission element piston 9 through activating shaft 13. Spring 11 remains in its base position because of the partial tightness brought about by transmission element brake cylinder 7 and sealing element 23 as it will be described later. In this manner the medium in the cylinder can flow from the first chamber 19 to the second chamber 21 through an opening 25 ensuring only a flow-through A1. The restrained flow-through ensured and determined by opening 25 implies great resistance as a result of which displacement of the transmission element piston 9 is slowed down in the transmission element brake cylinder 7. Due to the resistance of medium the transmission element 1 is also displaced and its exit portion 5 mechanically acts on the surface to be activated 15 so that it is displaced by a length L1.

In FIG. 3 a third fundamental state of the above described device according to the invention is shown. Operating force F1 still acts on controller 37. Together with it the activating shaft 13 and the transmission element piston 9 remain pressed in and do not move. In this case the portion to be activated 45 fixed to the surface to be activated 15 returns to its base position (zero setting) L0 as spring 17 acts due to a force F2 exerted for example by a controlled valve since the force exerted by spring 11 is smaller than the sum of force F2 and the force exerted by spring 17. To attain this displacement the medium in the transmission element brake cylinder 7 must flow from the second chamber 21 into the first chamber 19 through an opening 27 ensuring a flow-through A2. Preferably, in this case flow-through A2 ensured by opening 27 is greater than flow-through A1 ensured by opening 25. Consequently the resistance of medium is smaller, so the braking effect on displacement in this direction is insignificant. If application of force F1 is terminated, spring 11 returns transmission element 1 into its base position that is in the state of rest as it is shown in FIG. 1 and the process can be started again.

To sum up the foregoing discussion, the following can be said. The invention is a transmission element device for two-way timing. It is connected mechanically to a surface to be activated 15 of a timed apparatus operated by a controller 37, wherein the surface to be activated is linearly movable against counter-force. The transmission element 1 has a transmission element brake cylinder 7 filled with liquid form or gaseous operating medium. The inner space of the transmission element brake cylinder 7 is divided into a first chamber 19 and a second chamber 21 by means of a linearly moving transmission element piston 9 provided with a sealing element 23. The transmission element piston 9 is provided with openings 25, 27 for ensuring flow of the operating medium between the first chamber 19 and the second chamber 21 in an extent A1 and A2 determined separately for the two directions. Between the exit portion 5 of the transmission element 1 and the surface to be activated 15 there is a push contact while the transmission element piston 9 and the controller 37 are fixedly built together.

In FIG. 4 a possible application of the device according to the invention is shown. In this example the transmission element 1 controls opening of valve 35. Vertical arrows show the flow direction of the medium (e.g. tap water) to be controlled by valve 35. Operating force acting on controller 37 operates transmission element 1 through activating shaft 13. Transmission element 1 indirectly transmits the operating force to the surface to be activated 15 and opens valve 35 which is then controlled as it was described with reference to FIGS. 1, 2 and 3 according to a defined timing.

The transmission element according to the invention is able to eliminate the problem resulting from malfunction of the operating element e.g. controller 37 for example when it remains pushed in. It also can be adapted subsequently to valves and apparatuses for timing of them. An example for this application is shown in FIG. 5. In this example transmission element 1 is placed externally to valve 35 as a separate unit. In this manner the timing mechanism in the transmission element can be protected against contaminated or dangerous e.g. corrosive or hot or cold medium flowing through valve 35. Transmission element 1 is coupled to valve 35 by means of a fixing element 43 so that its displacement is prevented. Operating force acting on controller 37 indirectly operates transmission element 1 through activating shaft 13. In this example the medium in transmission element brake cylinder 7 flows with a different rate in each direction through opening 25 ensuring a “great” flow-through A1 and through opening 27 ensuring a “small” flow-through A2. Because of the braking effect resulting from the different extent of flow-through it flows more slowly (timed) in one of the directions than in the opposite direction. Pressing of controller 37 and also opening of valve 35 take place in a shorter time than returning to the base position (zero setting) which is induced by springs 11 and 17 when controller 37 is released.

FIG. 6 shows another possible example for application. Here, valve 35 is a timed valve provided with an auxiliary valve which can be opened by means of transmission element 1. Transmission element 1 is coupled to valve 35 by means of a fixing element 43 so that its displacement is prevented. In this manner transmission element 1 is taken out of the path of the flowing medium.

In the example shown in FIG. 7 transmission element 1 is built in valve 35 as a separate unit. In this example controller 37 is realized as the press-button of valve 35 provided with a press-button spring 39.

In FIG. 8 the transmission element 1 according to the invention can be seen provided with a possible transmission element piston 9. In this embodiment the sealing element 23 is an O-ring.

In FIGS. 9 and 10 a possible embodiment for ensuring the different but well defined extent of the two-way flow between transmission element piston 9 and sealing element 23 according to FIG. 8 is shown. In the wall of the groove formed in transmission element piston 9 for receiving sealing element 23 one or more small channels, slits are cut. The O-ring the elasticity of which is limited cannot fill them in entirely. In this manner when the sealing element 23 moves to the left as it is shown in FIG. 9, then to the right as it is shown in FIG. 10, the groove does not get entirely closed, making flow-through A1 and A2 possible. Naturally, openings 25 and 27 ensuring the control of the two-way flow-through may be formed in various ways. To sum it up, FIG. 9 shows the sealing element 23 as an O-ring in a position when it gets close to opening 25 ensuring a (“small”) flow-through A1 as an effect of force F1 acting on transmission element piston 9 (thin dotted line). In this position the extent of the flow-through of the medium at the two sides of the transmission element piston 9 is smaller than in its other position, which is shown in FIG. 10. FIG. 10 shows the sealing element 23 as an O-ring in a position when it gets close to opening 27 ensuring a (“great”) flow-through A2 as an effect of force F2 acting on transmission element piston 9 (thick dotted line). In this position the extent of the flow-through of the medium at the two sides of the transmission element piston 9 is greater than in its other position, which is shown in FIG. 9. The dimension ratio and the shape of openings 25 and 27 may be optional.

A few possible embodiments of transmission element piston 9 are shown in FIGS. 11, 12 and 13.

In the embodiment of FIG. 11 the different extent of flow-through is ensured by a micro-piston 29 formed in transmission element piston 9 of transmission element 1.

FIG. 12 shows a transmission element 1 whose transmission element piston 9 is provided with an edge sealing 31 suitable only for unidirectional sealing. Control of the flow-through in the other direction takes place by means of a micro-piston 29. This solution is especially advantageous when the difference in the extent of the flow-through in the two directions should be great.

In FIG. 13 the transmission element piston 9 of the transmission element 1 is provided with a dimensioned control-opening 33 which may be formed as any kind of geometrical shape, e.g. bore-hole, conical bore-hole, etc.

In the embodiment shown in FIG. 14 the transmission element brake cylinder 7 of the transmission element 1 is built in a rod assembly 47 for better space utilization. Rod assembly 47 contacts to the surface to be activated 15 of valve 35.

In FIG. 15 the transmission element 1 is built in the exiting side of valve 35 as a separate unit.

In the embodiment shown in FIG. 16 a dimensioned control opening 33 is formed in the transmission element brake cylinder 7 which together with the openings 25, 27 or even independently of them is suitable for realizing the control process according to the invention, if this control opening 33 is not intended to be formed in the piston or only in the piston. The bore-hole may be replaced by any kind of controlling element which ensures a well-defined moderate, restrained flow-through.

In FIG. 17 the transmission element 1 is built in the entering side of valve 35. Additionally, the transmission element brake cylinder 7 is provided with an equalizing bore-hole 41 in order to equalize the differences in the volume and/or to produce pressure differences. Equalizing bore-hole 41 can also be used for controlling.

FIG. 18 shows an embodiment in which transmission element 1 is built in reversely. Here the activating shaft 13 contacts to the surface to be activated 15. In this case the transmission element exit portion 5 may function as a press-button.

In FIGS. 1, 2, 3 and 5, 6, 7 the main functioning of the device according to the invention has been shown.

Any one from the sealing elements, the control openings 25, 27, the micro-piston 29 and/or the control opening 33 shown in FIGS. 8-13 may be combined with any of them. A different solution is also feasible, e.g. transmission element piston 9 can be replaced by a membrane system.

The embodiments shown in FIGS. 1-18 and variations of them are suitable not only for controlling, timing valves, but they can be used in any cases where timing or duration of timing is required. Transmission element 1 may be used independently or may be built in forming a part of an apparatus. As an example an electric switch e.g. bell press-button can be mentioned which produces a fixed ringing time.

1. Transmission element device for two-way timing connected mechanically to a surface to be activated (15) of a timed apparatus operated by a controller (37), the surface to be activated (15) is linearly movable against counter-force, characterized in that said transmission element (1) has a transmission element brake cylinder (7) filled with liquiform or gaseous operating medium, the inner space of said transmission element brake cylinder (7) is divided into a first chamber (19) and a second chamber (21) by means of a linearly moving transmission element piston (9) provided with a sealing element (23), said transmission element piston (9) is provided with openings (25, 27) for ensuring the flow of the operating medium between said first chamber (19) and said second chamber (21) in an extent (A1, A2) determined separately for each direction, the exit portion (5) of said transmission element (1) is in push contact with said surface to be activated (15), while said transmission element piston (9) is structurally fastened to said controller (37).

2. Transmission element device according to claim 1 characterized in that said timed apparatus is a valve (35).

3. Transmission element device according to claim 1 characterized in that said timed apparatus is an electric switch.

4. Transmission element device according to claim 1 characterized in that said sealing element (23) is an O-ring, and at least one of said openings (25, 27) for ensuring the flow of the operating medium in an extent (A1, A2) determined separately for each direction is formed by one or more small channels, slits cut in the wall of a groove formed for receiving the O-ring in said transmission element piston (9).

5. Transmission element device according to claim 1 characterized in that at least one of said openings (25, 27) for ensuring the flow of the operating medium in an extent (A1, A2) determined separately for each direction is a micro-piston (29) placed in said transmission element piston (9).

6. Transmission element device according to claim 1 characterized in that at least one of said openings (25, 27) for ensuring the flow of the operating medium in an extent (A1, A2) determined separately for each direction is a control-opening (33) formed in said transmission element brake cylinder (7).

7. Transmission element device according to claim 2 characterized in that it is built in said valve (35).

8. Transmission element device according to claim 1 characterized in that it is coupled to said timed apparatus by means of an external fixing element (43).

9. Transmission element device according to claim 1 characterized in that said transmission element brake cylinder (7) is built in a rod assembly (47) which contacts to the surface to be activated (15).

10. Transmission element device according to claim 1 characterized in that said transmission element brake cylinder (7) is provided with an equalizing bore-hole (41).

11. Transmission element device for two-way timing connected mechanically to a surface to be activated (15) of a timed apparatus operated by a controller (37), the surface to be activated (15) is linearly movable against counter-force, characterized in that said transmission element (1) has a transmission element brake cylinder (7) filled with liquid form or gaseous operating medium, the inner space of said transmission element brake cylinder (7) is divided into a first chamber (19) and a second chamber (21) by means of a linearly moving transmission element piston (9) provided with a sealing element (23), said transmission element piston (9) is provided with openings (25, 27) for ensuring the flow of the operating medium between said first chamber (19) and said second chamber (21) in an extent (A1, A2) determined separately for each direction, the exit portion (5) of said transmission element (1) represents said controller (37) while the activating shaft (13) of said transmission element piston (9) is in push contact with said surface to be activated (15).
